(19) United States
(12) Patent Application Publication
(10) Pub. No.: US 2008/0114148 A1
(43) Pub. Date: May 15, 2008

(54) Manufacturing method for polyimide resin containing a norbornene group

(76) Inventor: Shen Jason Chou, Irvine, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 11/595,874

(22) Filed: Nov. 13, 2006

(51) Int. Cl. C08G 69/04

(52) U.S. Cl. 528/274; 528/368

(57) ABSTRACT

A manufacturing method for polyimide resin containing a norbornene group is disclosed. Take Nadic anhydride to react with diamine compound to form dinorbornene polyimide. Then the dinorbornene polyimide reacts with diisocyanate compounds to produce polyimide resin containing a norbornene group. The polyimide resin containing a norbornene group has good adhesion and electrical properties and is applied to glass fiber, copper foil, coating agents, molding materials and adhesives for generating printed circuit boards by hot pressing.

### BACKGROUND OF THE INVENTION

The present invention relates to a manufacturing method for polyimide resin, especially to a manufacturing method for polyimide resin containing a norbornene group.

Refer to FIG. 1, imide acid containg a nadic group synthesized from Nadic anhydride (NA) and 4-aminobenzoic acid is reacted with 4,4′-ODA or modified diamine compound containing an amide group to form polyimide oligomer by direct condensation. Then through addition reaction, crosslinked polyimide resin is obtained. The peel strength of polyimide resin is higher than general business standard. Moreover, the heat resistance, chemical resistance and electrical properties thereof are all excellent. Therefore, it is a kind of thermal stable adhesive with good processing properties.

The Polyamide acid (PAA) is prepared by diamine prepolymer, Pyromellitic dianhydride (PMDA), 3, 3′,4,4′-Diphenylsulfone tetracarboxylic dianhydride (DSDA) and 3,3′,4, 4′-Benzophenoneteracarboxylic dianhydride (BTDA). After multi-stage heating and drying processes, it becomes PAI membrane and is tested by differential scanning calorimetry (DSC) and Thermogravity analysis (TGA). The glass transition temperature of the membrane ranges between 336˜371° Degrees Celsius with good thermal stability and good resistance to organic solvents.

Benzoic acid with an imide group obtained from Nadic anhydride (NA) and 4-aminobenzoic is reacted with 4,4′-ODA to form Polyamide-imide (PAI). Thermal properties and processing requirements of the polymer is measured by differential scanning calorimetry (DSC) and Thermogravity analysis (TGA). Moreover, surface treatment is carried out on glass fiber combined with colloidal silica with diameter of 22 nm and then is treated with zircoaluminate coupling agent. The processed glass fiber together with synthesis PAI and copper foil are hot pressed to form copper clad laminate. The properties of the copper clad laminate are expressed by peel strength, dielectric constant and loss tangent. The results show the peel strength and the electrical properties (Dk, Df) of the laminate is far more better than the FR-4 laminate available now.

In studies on thermal stable polyimide resin and copper foil composite materials, PMR (Polymerization of monomer reactants, polyimide resin obtained by PMR (Polymerization of monomer reactants) is prepared by reactions of three kind of monomers, 5-norbornene-2,3′-dicarboxylic anhydride(NA), 3,4′-oxydianiline(3,4′-ODA) and BTDA. Then the resin together with copper foil are pressed to form composite material. The peel strength, thermal stability, chemical resistance, dielectric constant and dissipation factor of the material are discussed. Moreover, the modified PAI resin is synthesis by three monomers-Nadic anhydride (NA), 4-aminobenzoic acid, and 3, 4′-oxydianiline and the properties of this composite material are also researched. Furthermore, Amide-Containing bisnadimide (ACBI) is synthesized from Nadic anhydride (NA), 4-aminobenzoic acid, 4,4′-oxydianiline and 4-nitrobenzylchloride. Chemical structure of the resin is identified by elemental analysis, Fourier Transform Infrared spectrometry(FTIR), and X-ray while hot properties is by TGA and adhesive performance of ACBI/copper foil composite material is by scanning electron microscope (SEM). The results of peel strength, thermal stability, chemical resistance, dielectric constant and dissipation factor thereof show it is suitable for PCB (printed circuit board) manufacturing and applications.

The PI-prepolymer synthesis from MDI and BTDA is added with various kind of diacid monomer to form PAI. The structure of synthesis PAI is identified by elemental analysis, Fourier Transform Infrared spectrometry (FTIR), and X-ray while solubility, heat properties, mechanical properties and electrical properties thereof are also tested. The results show that the PAI is well dissolved in polar solvents such as NMP, DMSO, DMAc. In Dynamic Mechanical Analysis (DMA), the glass transition temperature of the membrane ranges between 230˜236°Celsius degrees. During a thermogravimetric analysis (TGA), under condition N, temperature of 10% weight loss ranges from 495˜505°degrees Celsius. The tensile strength ranges from 70˜85 Mpa, elongation rate is 5.5˜7.5%, dielectric constant is between 2.7˜2.9, and the dissipation factor is no more than 0.003.

Refer to U.S. Pat. No. 4,110,364 applied by Japanese company Mitsubishi Gas Chemical, in 1975, maleimide monomers are added with melamine resin to form excellent BT resin. After being modified by addition of epoxy resin, the company has more or less cornered the resin market for thirty years. In 1997, in similar way, Taiwanese Chung Shan Wang and Hang-Zen Huang have applied U.S. Pat. No. 5,886,134. In 2002, Japanese company Matsushita Electric Industrial Co., Ltd has applied U.S. Pat. No. 192,485A1 and revealed a method to manufacture new PCB in which thickness of the resin between the laminates is only 5˜10 μm.

Besides requirements of physical properties, absorbent rate of the laminate, heat resistance, moisture resistance, chemical resistance of synthesis resin are also detected. The Impedance Analyzer is used to detect dielectric constant. The main purpose of the present invention is to modify the synthesis resin such as modification of melamine resin and adding polyimide monomer with di-amine for improved flexibility. The ultimate purpose is to produce a new heat-resistant resin for industrial applications.

### SUMMARY OF THE INVENTION

Therefore it is a primary object of the present invention to provide a manufacturing method for polyimide resin containing a norbornene group that provides polyimide resin with better mechanical properties, heat resistance, chemical resistance, moisture absorbance and electrical properties.

In order to achieve above object, the present invention provides a manufacturing method for polyimide resin containing a norbornene group that takes Nadic anhydride to react with diamine compound for producing dinorbornene polyimide. Then the dinorbornene polyimide reacts with diisocyanate compounds to generate polyimide resin containing a norbornene group.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic drawing showing chemical equation of crosslinking polyamide-imide manufactured by conventional technology;

FIG. 2 is a schematic drawing showing chemical equation of an embodiment of polyimide monomer manufactured by the present invention;

FIG. 3 is a schematic drawing showing chemical equation of another embodiment of polyimide monomer manufactured by the present invention;

FIG. 4 is a schematic drawing showing chemical equation of a further embodiment of polyimide monomer manufactured by the present invention;

FIG. 5 is a schematic drawing showing chemical equation of an embodiment of dinitro-compound containing an amide group manufactured by the present invention;

FIG. 6 is a schematic drawing showing chemical equation of another embodiment of diamine compound containing an amide group manufactured by the present invention;

FIG. 7 is a schematic drawing showing chemical equation of a further embodiment of polyimide monomer manufactured by the present invention;

FIG. 8 is a schematic drawing showing chemical equation of a further embodiment of polyimide-cyanate ester resin manufactured by the present invention;

FIG. 9 is a schematic drawing showing chemical equation of an embodiment of polyimide diamine resin manufactured by the present invention;

FIG. 10 is a schematic drawing showing chemical equation of a further embodiment of polyimide-cyanate ester resin manufactured by the present invention.

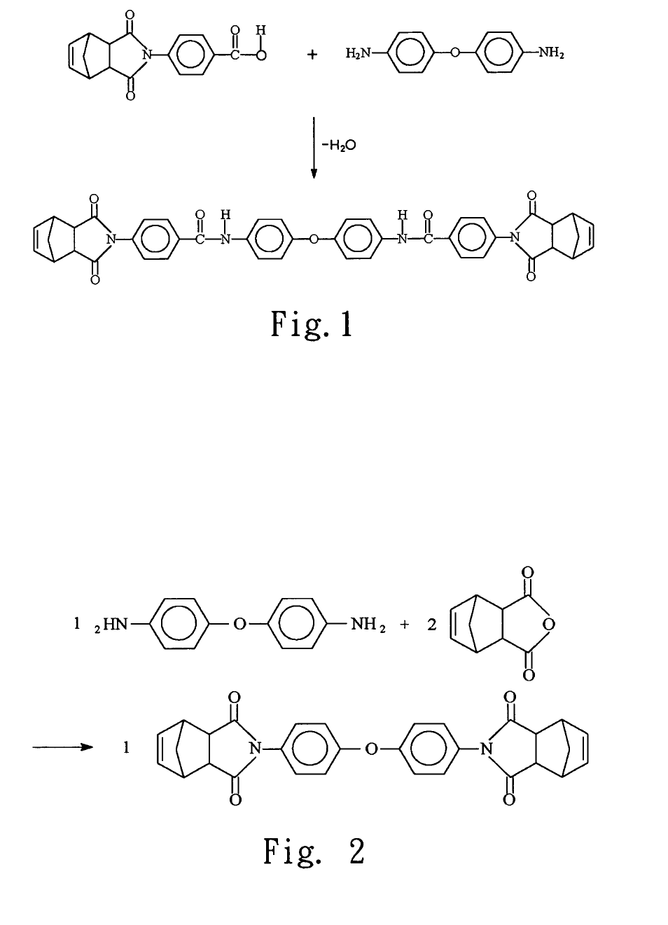

### DETAILED DESCRIPTION OF THE PREFERRED EMBODIMENT

A manufacturing method for polyimide monomer containing a norbornene group is described as following:

### EXAMPLE 1

### Manufacturing the Polyimide Monomer

Take 0.1 mole 4,4′-Diamino dipheyl ether (4,4′-ODA) and 0.2 mole 5-norbornene-2,3′-dicarboxylic anhydride (Nadic anhydride), dissolve them in 150 ml N,N′-dimethylforamide (DMF) and stir the solution at room temperature until dissolved. After being stirred, the solution is heated to increase temperature slowly to 145° C., keep the solution in this temperature and bring the solution to reflux for two hours. After being cooled, pour the solution into 850 ml water and precipitate is formed. Filter the precipitate and the wash the filtrate with methyl alcohol and distilled water. Repeat the filtering and washing step for 3 to 4 times. At last, the washed filtrate is dried in an oven at 110° C. to obtain white powder—Bis[4-(N-nadimide)phenyl]ether. The yield rate is 85%. Refer to FIG. 2, chemical equation of this embodiment is shown.

### EXAMPLE 2

### Manufacturing the Polyimide Monomer

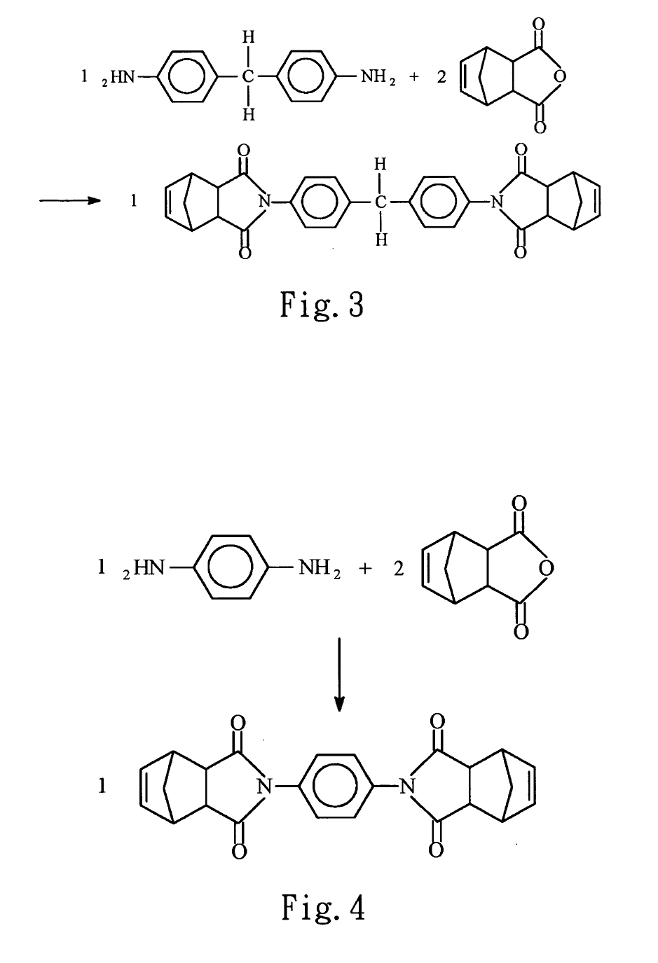

Take 0.1 mole 4,4′-Methylenedianiline (MDA) and 0.2 mole 5-norbornene-2,3′-dicarboxylic anhydride (Nadic anhydride), dissolve them in 150 ml N,N′-dimethylforamide (DMF) and stir the solution at room temperature until dissolved. Then the stirred solution is heated to increase temperature slowly to 145° C., keep the solution in this temperature and bring the solution to reflux for two hours. After being cooled, pour the solution into 850 ml water and precipitate is formed. Filter the precipitate and the wash the filtrate with methyl alcohol and distilled water. Repeat the filtering and washing steps for 3 to 4 times. Finally, the washed filtrate is dried in an oven at 110° C. to obtain yellow powder-Bis[4-(N-nadimide)phenyl]methane. The yield rate is 79%. Refer to FIG. 3, chemical equation of this embodiment is shown.

### EXAMPLE 3

### Manufacturing the Polyimide Monomer

Take 10.81 g p-Phenylenediamine (PPD) and 32.83 g 5-norbornene-2,3′-dicarboxylic anhydride (Nadic anhydride) while the molar ratio therebetween is 1:2. Dissolve them in 150 ml N,N′-dimethylforamide (DMF) and stir the solution at room temperature until dissolved. Then the stirred solution is heated to increase temperature slowly to 145° C., keep the solution in this temperature and bring the solution to reflux for two hours. After being cooled, pour the solution into 850 ml water and precipitate is formed. Filter the precipitate and the wash the filtrate with methyl alcohol and distilled water. Repeat the filtering and washing step for 3 to 4 times. At last, the washed filtrate is dried in an oven at 110° C. to obtain white powder-p-4-(N-nadimide)benzene. The yield rate is 80%. Refer to FIG. 4, chemical equation of this embodiment is shown.

### EXAMPLE 4

### Manufacturing dinitro-Compound Containing an Amide Group

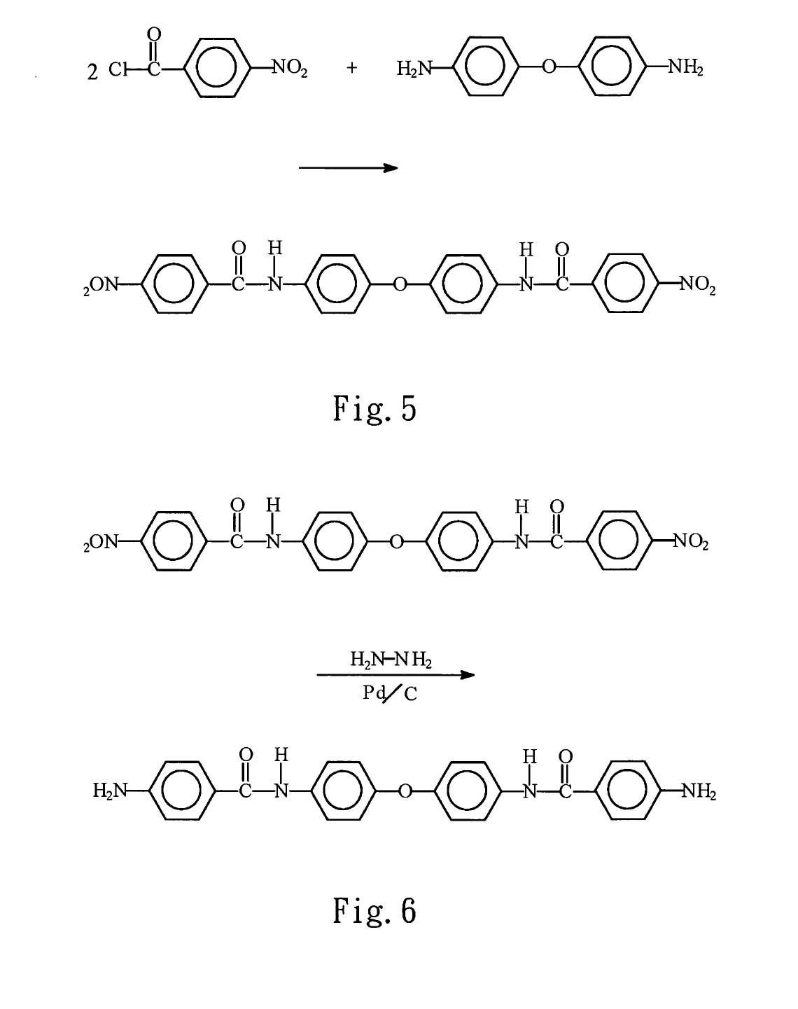

Dissolve 9 g sodium hydroxide into 200 ml distilled water, add 0.1 mole 4,4′-Diamino dipheyl ether into the solution and stir the solution to react. Next add the mixture of 0.2 mole Nitrobenzoyl chloride and 40 ml Tetrahydrofuran (THF) into the solution and allowed to react for one hour. After filtering, purification, and vacuum dried at 100° C. for about 8 hours, white powder-bis-[Nitrophenylcarbonylaminophenyl] ether is obtained. The yield rate is 85%. The chemical equation of this embodiment is shown in FIG. 5.

### EXAMPLE 5

### Manufacturing Diamine Compound Containing an Amide Group

Dissolve 0.04 mole dinitro compound containing amide group of example 4 into 200 ml alcohol and then add 0.3 g Palladium/carbon into the solution. Next add the hydrazine hydrate at 60° C. and allow the solution to react for 2 hours when the it arrives 70° C.. Now add into 200 ml THF for hydrogenation and allowed to react for one hour. After filtering and condensation, brown powder 4,4′-oxybis[α,αDiphenylamino (p-carbonylphenylamine) is obtained. The yield rate is 79% and the chemical equation of this embodiment is shown in FIG. 6.

### EXAMPLE 6

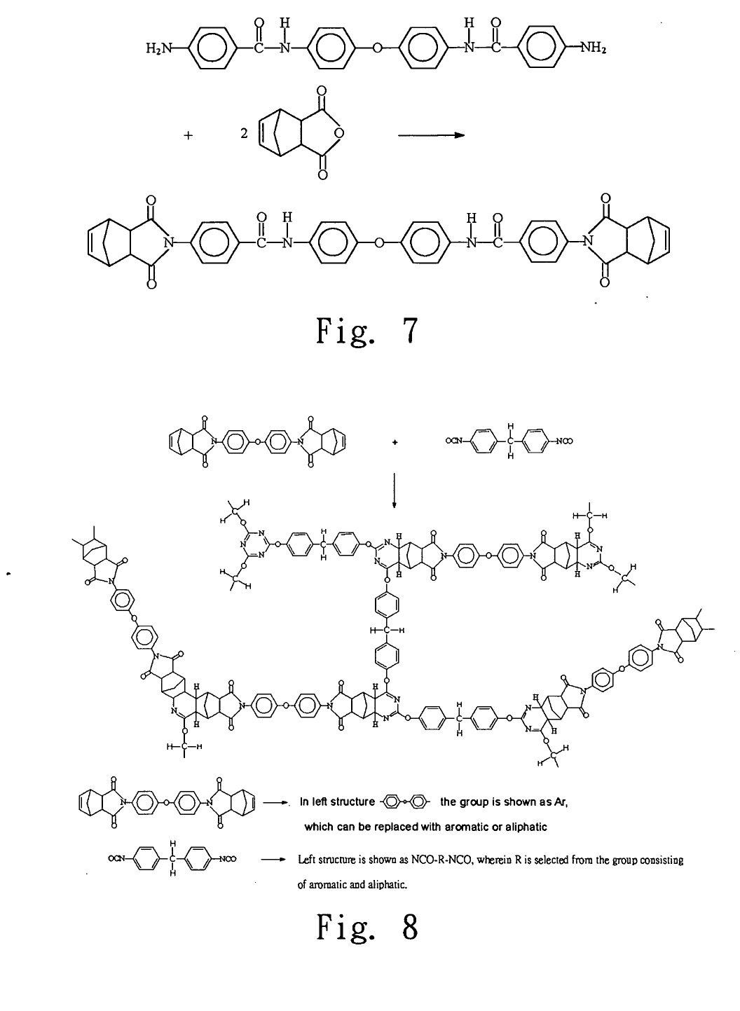

Take 21.9 g diamine compound containing an amide group and 16.42 g 5-norbornene-2,3′-dicarboxylic anhydride (NA) with the molar ratio therebetween 1:2. Dissolve them in 120 ml N,N′-dimethylforamide (DMF) and stir the solution at room temperature until dissolved. Then the stirred solution is heated for increasing temperature slowly to 145° C., keep the solution in this temperature and bring the solution to reflux for two hours. After being cooled, pour the solution into 850 ml water and precipitate is formed. Filter the precipitate and the wash the filtrate with methyl alcohol and distilled water. Repeat the filtering and washing step for 3 to 4 times. At last, the washed filtrate is dried in an oven at 110° C. to obtain brown powder N-nadimide polyamide with yield rate of 83.5%. Refer to FIG. 7, the chemical equation of this embodiment is shown.

Furthermore, manufacturing methods for polyimide resin containing a norbornene group are described as followings:

Experiment 1

Take 0.1 mole diphenylmethane diisocyanate (MDI) as well as 0.1 mole self-prepared polyimide monomer and dissolve them into mixture of 30 ml (N-Methyl Pyrrolidone (NMP) and 30 ml DMF. Stir the solution at a constant speed under room temperature and then 200 ppm catalyst as well as 200 ppm auxiliary agent is added sequentially. The catalyst is selected from organic metal salts containing copper, manganese, tin, iron or zinc while the auxiliary agent is phenol(hydroxybenzene), 2-phenylimidazole, 2-ethyl-4-methylimidazole, catechol, 1-methylimidazole or nonyl phenol. After finishing addition of the drugs, heat the stirred solution into 150˜180° C. slowly. After 10 to 20 minutes, the stirred solution thickens due to solvent evaporation. Keep heat the solution to 200˜250° C. and the solution becomes sticky, glue-like and unable to be stirred any more. After the glue-like resin becoming hard, let it cool down. Refer to FIG. 8, the chemical equation of this embodiment is shown.

Experiment 2

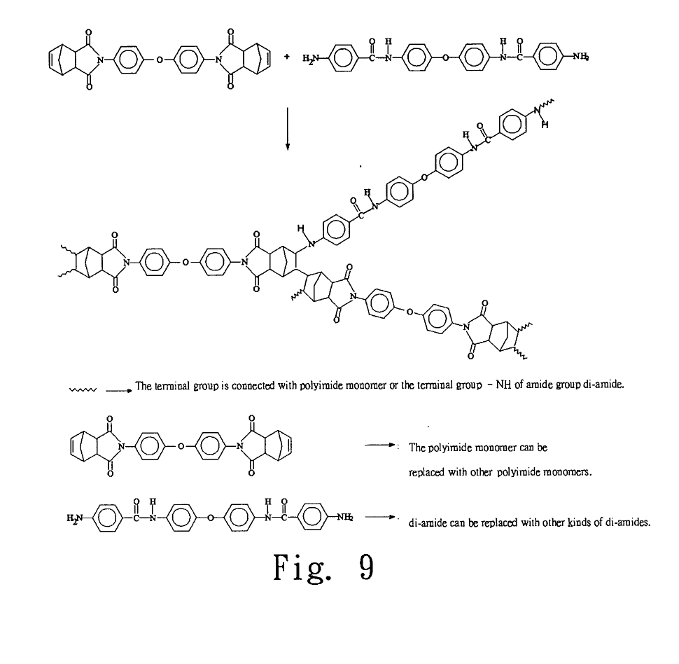

Take certain amount of self-prepared imide-diamines, preferably no more than 1 mole (≦1) together with 0.1 mole self-prepared polyimide monomer and dissolve them into 30 ml N-Methyl Pyrrolidone (NMP). Then stir the solution at a constant speed under room temperature and the temperature of the solution increases into 150˜180° C. slowly. After 10˜20 minutes, paint the solution on glass fiber. After being dried, the coated glass fiber is stacked on copper foil for hot pressing. While being hot pressed, end group of the polyimide monomer undergoes Reverse-Diels-Alder Reaction while double bond of the Nadic anhydride is opened at high temperature and is bonded with a —HN group of the imide-diamines to form corsslinking network. Refer to FIG. 9, the chemical equation of this embodiment is shown.

Experiment 3

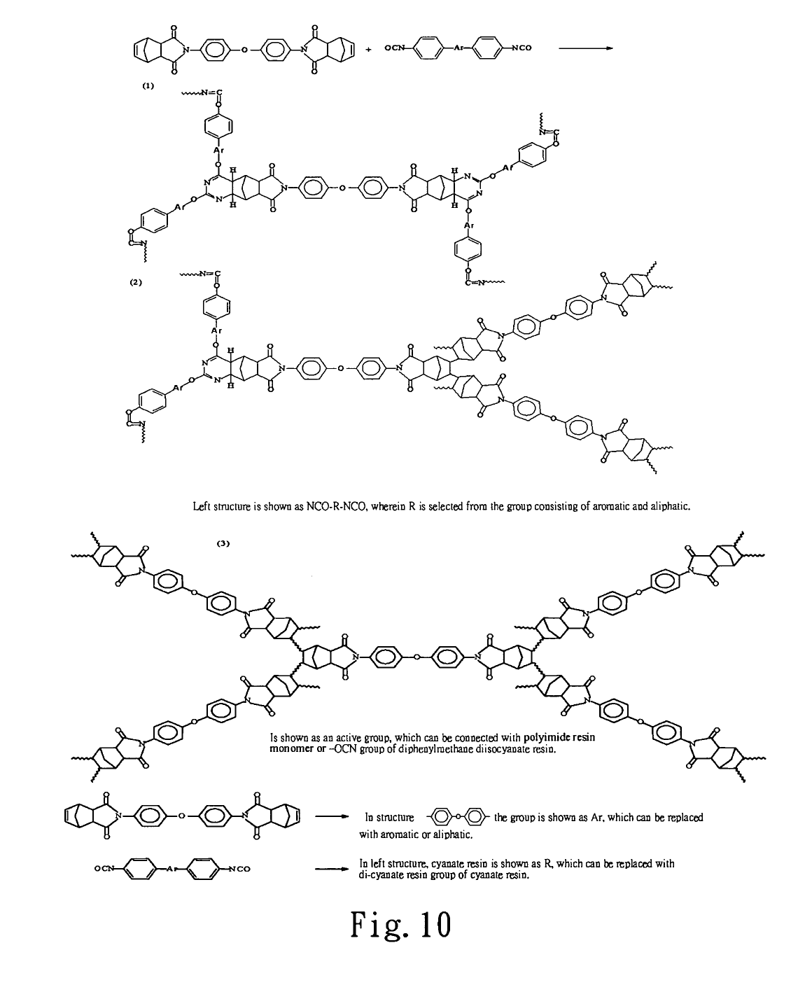

Take certain amount of Diphenylmethane diisocyanate (MDI), preferably no more than 0.1 mole (≦0.1), together with 0.1 mole self-prepared polyimide monomer and dissolve them into 30 ml N-Methyl Pyrrolidone(NMP). Then stir the solution at a constant speed under room temperature and the temperature of the solution increases into 150˜165° C. slowly. After 10˜30 minutes, paint the solution on glass fiber. After being dried, the coated glass fiber is stacked on copper foil for hot pressing. While being hot pressed, end group of the polyimide monomer undergoes Reverse-Diels-Alder Reaction while double bond of the Nadic anhydride is opened at high temperature so that the monomers joined with each others to get crosslinking. Or the monomer is bonded with a —OCN group of the MDI to form corsslinking network. Refer to FIG. 10, the chemical equation of this embodiment is shown.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A manufacturing method for polyimide-cyanate ester resins containing a norbornene group comprising the steps of:
dissolving NCO—R—NCO compound and polyimide resin containing a norbornene group into a multiple of solvents of N-Methyl Pyrrolidone (NMP) and N,N′-dimethylforamide while R is selected from aliphatic group or aromatic group;
adding a catalyst and an auxiliary agent; and
evaporating the solvents to get sticky glue-like substance.

2. The method as claimed in claim 1, wherein a manufacturing method for the polyimide resin containing a norbornene group comprising the steps of:
dissolving 4,4′-Diamino dipheyl ether as well as nadic anhydride in N,N′-dimethylforamide; and
stirring the solution at room temperature until dissolved, then the stirred solution is heated to raise temperature slowly, poured into water and precipitate is formed; filtering the precipitate and the precipitate is polyimide resin containing a norbornene group.

3. The method as claimed in claim 1, wherein a manufacturing method for the polyimide resin containing a norbornene group comprising the steps of:
dissolving 4,4′-Methylenedianiline and nadic anhydride in N,N′-dimethylforamide; and stirring the solution at room temperature until dissolved , then the stirred solution is heated to raise temperature slowly, cooled down, poured into water and precipitate is formed; filtering the precipitate and the precipitate is polyimide resin containing a norbornene group.

4. The method as claimed in claim 1, wherein a manufacturing method for the polyimide resin containing a norbornene group comprising the steps of:
dissolving p-Phenylenediamine and nadic anhydride in N,N′-dimethylforamide; and stirring the solution at room temperature until dissolved, then the stirred solution is heated to raise temperature slowly, cooled down, poured into water and precipitate is formed; filtering the precipitate and the precipitate is polyimide resin containing a norbornene group.

5. The method as claimed in claim 1, wherein a manufacturing method for the polyimide resin containing a norbornene group comprising the steps of:
dissolving diamine compound containing an amide group and nadic anhydride in N,N′-dimethylforamide; and
stirring the solution at room temperature until dissolved; then after being cooled down, pouring the solution into water and precipitate is formed; filtering the precipitate and the precipitate is polyimide resin containing a norbornene group.

6. The method as claimed in claim 5, wherein a manufacturing method for the diamine compound containing an amide group comprising the steps of:
dissolving sodium hydroxide in distilled water, adding 4,4′-Diamino dipheyl ether into the solution and then stirring the solution;
adding mixture of Nitrobenzoyl chloride and Tetrahydrofuran into the solution to react and obtaining dinitro compound containing an amide group after filtering the solution;
dissolving dinitro compound containing an amide group in alcohol and adding Palladium/carbon and hydrazine hydrate into the solution sequentially; and
adding into 200 ml Tetrahydrofuran for hydrogenation and obtaining diamine compound containing an amide group after filtering.

7. A manufacturing method for polyimide diamine resins containing a norbornene group comprising the steps of:
dissolving imide-diamines and polyimide resin containing a norbornene group in N-Methyl Pyrrolidone; and
making an end group of the polyimide resin undergo Reverse-Diels-Alder Reaction while double bond of the nadic anhydride is opened and is bonded with a —HN group on end of the imide-diamines to form corsslinking network.

8. The method as claimed in claim 7, wherein a manufacturing method for the polyimide resin containing a norbornene group comprising the steps of:
dissolving 4,4′-Diamino dipheyl ether as well as nadic anhydride in N,N′-dimethylforamide; and
stirring the solution at room temperature until dissolved, then the stirred solution is heated to raise temperature slowly, poured into water and precipitate is formed; filtering the precipitate and the precipitate is polyimide resin containing a norbornene group.

9. The method as claimed in claim 7, wherein a manufacturing method for the polyimide resin containing a norbornene group comprising the steps of:
dissolving 4,4′-Methylenedianiline and nadic anhydride in N,N′-dimethylforamide; and stirring the solution at room temperature until dissolved, then the stirred solution is heated to raise temperature slowly, cooled down, poured into water and precipitate is formed; filtering the precipitate and the precipitate is polyimide resin containing a norbornene group.

10. The method as claimed in claim 7, wherein a manufacturing method for the polyimide resin containing a norbornene group comprising the steps of:
dissolving p-Phenylenediamine and nadic anhydride in N,N′-dimethylforamide; and
stirring the solution at room temperature until dissolved, then the stirred solution is heated to raise temperature slowly, cooled down, poured into water and precipitate is formed; filtering the precipitate and the precipitate is polyimide resin containing a norbornene group.

11. The method as claimed in claim 7, wherein a manufacturing method for the polyimide resin containing a norbornene group comprising the steps of:
dissolving diamine compound containing an amide group and nadic anhydride in N,N′-dimethylforamide; and
stirring the solution at room temperature until dissolved; then after being cooled down, pouring the solution into water and precipitate is formed; filtering the precipitate and the precipitate is polyimide resin containing a norbornene group.

12. The method as claimed in claim 11, wherein a manufacturing method for the diamine compound containing an amide group comprising the steps of
dissolving sodium hydroxide in distilled water, adding 4,4′-Diamino dipheyl ether into the solution and then stirring the solution;
adding mixture of Nitrobenzoyl chloride and Tetrahydrofuran into the solution to react and obtaining dinitro compound containing an amide group after filtering the solution;
dissolving dinitro compound containing an amide group in alcohol and adding Palladium/carbon and hydrazine hydrate into the solution sequentially; and
adding into 200 ml Tetrahydrofuran for hydrogenation and obtaining diamine compound containing an amide group after filtering.

13. A manufacturing method for polyimide-cyanate ester resins containing a norbornene group comprising the steps of:
dissolving NCO—R—NCO compound and polyimide resin containing a norbornene group in N-Methyl Pyrrolidone while R is selected from aliphatic group or aromatic group; and
making end group of the polyimide monomer undergo Reverse-Diels-Alder Reaction and double bond of the nadic anhydride is opened so as to form crosslinking or is bonded with a —OCN group of the Diphenylmethane diisocyanate to form corsslinking network.

14. The method as claimed in claim 13, wherein a manufacturing method for the polyimide resin containing a norbornene group comprising the steps of:
dissolving 4,4′-Diamino dipheyl ether as well as nadic anhydride in N,N′-dimethylforamide; and
stirring the solution at room temperature until dissolved, then the stirred solution is heated to raise temperature slowly, poured into water and precipitate is formed; filtering the precipitate and the precipitate is polyimide resin containing a norbornene group.

15. The method as claimed in claim 13, wherein a manufacturing method for the polyimide resin containing a norbornene group comprising the steps of:
dissolving 4,4′-Methylenedianiline and nadic anhydride in N,N′-dimethylforamide; and
stirring the solution at room temperature until dissolved , then the stirred solution is heated to raise temperature slowly, cooled down, poured into water and precipitate is formed; filtering the precipitate and the precipitate is polyimide resin containing a norbornene group.

16. The method as claimed in claim 13, wherein a manufacturing method for the polyimide resin containing a norbornene group comprising the steps of:
dissolving p-Phenylenediamine and nadic anhydride in N,N′-dimethylforamide; and
stirring the solution at room temperature until dissolved, then the stirred solution is heated to raise temperature slowly, cooled down, poured into water and precipitate is formed; filtering the precipitate and the precipitate is polyimide resin containing a norbornene group.

17. The method as claimed in claim 13, wherein a manufacturing method for the polyimide resin containing a norbornene group comprising the steps of:
dissolving diamine compound containing an amide group and nadic anhydride in N,N′-dimethylforamide; and
stirring the solution at room temperature until dissolved; then after being cooled down, pouring the solution into water and precipitate is formed; filtering the precipitate and the precipitate is polyimide resin containing a norbornene group.

18. The method as claimed in claim 17, wherein a manufacturing method for the di amine compound containing an amide group comprising the steps of
dissolving sodium hydroxide in distilled water, adding 4,4′-Diamino dipheyl ether into the solution and then stirring the solution;
adding mixture of Nitrobenzoyl chloride and Tetrahydrofuran into the solution to react and obtaining dinitro compound containing an amide group after filtering the solution;
dissolving dinitro compound containing an amide group in alcohol and adding Palladium/carbon and hydrazine hydrate into the solution sequentially; and
adding into 200 ml Tetrahydrofuran for hydrogenation and obtaining diamine compound containing an amide group after filtering.

19. A manufacturing method for polyimide-cyanate ester resins containing a norbornene group comprising the steps of:
taking nadic anhydride to react with diamine compound for producing dinorbornene polyimide; and
making the dinorbornene polyimide react with NCO—R—NCO compound to form polyimide-cyanate ester resin containing a norbornene group while R is selected from aliphatic group or aromatic group;

20. The method as claimed in claim 19, wherein structure of the diamine compound is H₂N—R—NH₂ while R is selected from aliphatic group or aromatic group.

21. The method as claimed in claim 19, wherein in the step of making the dinorbornene polyimide react with NCO—R—NCO compound, at least a catalyst and an auxiliary agent are added in.

22. The method as claimed in claim 21, wherein the catalyst is organic metal salt containing copper, manganese, tin, iron or zinc.

23. The method as claimed in claim 21, wherein the auxiliary agent is phenol, 2-phenylimidazole, 2-ethyl-4-methylimidazole, catechol, 1-methylimidazole or nonyl phenol.
